(19) United States
(12) Patent Application Publication
(10) Pub. No.: US 2025/0029586 A1
(43) Pub. Date: Jan. 23, 2025

(54) Design of Acoustic Metamaterials Based on Liquid Crystal Skyrmions

(71) Applicant: UNIVERSITY OF SOUTH CAROLINA, COLUMBIA, SC (US)

(72) Inventors: MONIROSADAT SADATI, COLUMBIA, SC (US); JEREMY R. MONEY, LEXINGTON, SC (US); JOSE A. MARTINEZ-GONZALEZ, SAN LUIS POTOSI (MX)

(21) Appl. No.: 18/772,370

(22) Filed: Jul. 15, 2024

Related U.S. Application Data
(60) Provisional application No. 63/514,880, filed on Jul. 21, 2023.

(51) Int. Cl. G10K 11/162; B82Y 30/00; B82Y 40/00

(52) U.S. Cl. CPC G10K 11/162; B82Y 30/00; B82Y 40/00

(57) ABSTRACT

The disclosure deals with a system and method for the design of acoustic metamaterials based on liquid crystal skyrmions. Noise attenuation, sound focusing, and harvesting acoustic wave energy are challenging issues that the technological community currently faces. The disclosed thermodynamically driven metamaterial facilitates the design of unique architectures with several acoustic applications, including sound attenuation and acoustic energy harvesting. This disclosed structure includes spherical shells in a hexagonal arrangement (or cubic), which can be designed in any size and additively manufactured for end use applications.

### PRIORITY CLAIM

The present application claims the benefit of priority of U.S. Provisional Patent Application No. 63/514,880, titled Integrated and Design Of Acoustic Metamaterials Based On Liquid Crystal Skyrmions, filed Jul. 21, 2023, and which is fully incorporated herein by reference for all purposes.

### BACKGROUND OF THE PRESENTLY DISCLOSED SUBJECT MATTER

The disclosure generally deals with a system and method for the design of acoustic metamaterials, and more particularly for the design of acoustic metamaterials based on liquid crystal skyrmions.

Skyrmions can exist in a variety of materials such as ferromagnets, chiral magnets, and chiral liquid crystals. These phenomena are characterized by localized point-like topological defects within an orientational order parameter field with a constant magnitude, which cannot anneal away. In a full skyrmion, the director field in a chiral liquid crystal, makes a full 360-degree rotation as it moves from the skyrmion center to the periphery. In a half-skyrmion, on the other hand, the director field rotates radially by 180 degrees from the skyrmion center outward. Blue phase liquid crystal skyrmions represent a new class of topologically protected structures with unique properties that have the potential to lead to the discovery of new materials and devices with unprecedented functionality.

Metasurfaces and metamaterials are considered the new generation of structures and materials with unique electromagnetic, photonic, and acoustic properties. However, there are currently a limited number of structures available, and the design of these structures are expensive.

A wide range of materials are currently used for sound attenuation applications, including plastic foams, woven materials, mineral wool, and micro-perforated panels. However, continuous development in the field of acoustic metamaterials will provide plenty of useful technological advancements, including sound focusing, attenuation, elastic energy harvesting and acoustic cloaking.

### SUMMARY OF THE PRESENTLY DISCLOSED SUBJECT MATTER

The disclosure deals with a system and method for the design of acoustic metamaterials based on liquid crystal skyrmions. Noise attenuation, sound focusing, and harvesting acoustic wave energy are challenging issues that the technological community currently faces. The disclosed thermodynamically driven metamaterial facilitates the design of unique architectures with several acoustic applications, including sound attenuation and acoustic energy harvesting. This disclosed structure includes spherical shells in a hexagonal arrangement (or cubic), which can be designed in any size and additively manufactured for end use applications.

Here we introduce a thermodynamically driven approach based on the self-assembly of the liquid crystal structures to design unique skyrmion-like structures which can be used for a variety of acoustic applications. These structures are lightweight, tunable, and can be designed and built using 3D printing technology in any size or material, from flexible polymers to metals.

One exemplary embodiment of presently disclosed subject matter relates to acoustic metamaterials comprising designed skyrmion-like acoustic metamaterials structure formed by 3D printing to a desired structure size, with the acoustic metamaterials structure designed for at least one of sound focusing, sound attenuation, elastic/acoustic energy harvesting, and acoustic cloaking.

It is to be understood that the presently disclosed subject matter equally relates to associated and/or corresponding methodologies. One exemplary such method relates to a method for fabricating acoustic metamaterials, comprising designing an acoustic metamaterial structure based on skyrmion-like structures for acoustic applications; producing data for computationally simulating the designed acoustic metamaterial structure at a nanostructure level; converting the produced data to a 3D printer-readable file; scaling the 3D printer-readable file to a desired structure size; and 3D printing the skyrmion-like acoustic metamaterials structure.

Another exemplary such method relates to method for designing acoustic metamaterials based on liquid crystal skyrmions, comprising designing an acoustic metamaterial structure based on the self-assembly of liquid crystal structures for skyrmion-like structures for use for acoustic applications comprising at least one of sound focusing, sound attenuation, elastic/acoustic energy harvesting, and acoustic cloaking; using simulated nanoscale disclination networks for producing data for computationally simulating the designed acoustic metamaterial structure at a nanostructure level; converting the produced data to a 3D printer-readable file; scaling the 3D printer-readable file to a desired structure size; and 3D printing the skyrmion-like acoustic metamaterials structures.

Other example aspects of the present disclosure are directed to systems, apparatus, tangible, non-transitory computer-readable media, user interfaces, memory devices, and electronic devices for design of acoustic metamaterials. To implement methodology and technology herewith, one or more processors may be provided, programmed to perform the steps and functions as called for by the presently disclosed subject matter, as will be understood by those of ordinary skill in the art.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates a generally front and top perspective view of presently disclosed exemplary skyrmions produced from continuum simulation, represented on a scale of hundreds of nms;

FIG. 2 illustrates a generally front, left side, and top perspective view of presently disclosed exemplary skyrmions as represented in subject FIG. 1; and

FIG. 3 illustrates a generally front and top perspective view of presently disclosed exemplary skyrmions produced from 3D printing, represented on a scale of cms.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed generally to system and method for the design of acoustic metamaterials, and more particularly to the design of acoustic metamaterials based on liquid crystal skyrmions.

Here we use Landau-de Gennes mean-field theory to simulate the self-assembly of blue phase liquid crystals and their disclination networks and the conditions under which blue phase skyrmions can be formed and manipulated. The simulated nanoscale disclination networks will be converted to a printable format, scaled to any desired size, and 3D printed using different materials, including polymers and metals for acoustic applications.

The Landau-de Gennes theory relates to nematic liquid crystals, which is the simplest liquid crystalline phase of such matter with properties that are intermediate between a solid and a liquid. The structure tends to align along certain locally preferred directions i.e. exhibit long-range orientational ordering. A liquid crystal is itself a thermodynamic stable phase characterized by anisotropy of properties without the existence of a three-dimensional crystal lattice, generally lying in the temperature range between the solid and isotropic liquid phase

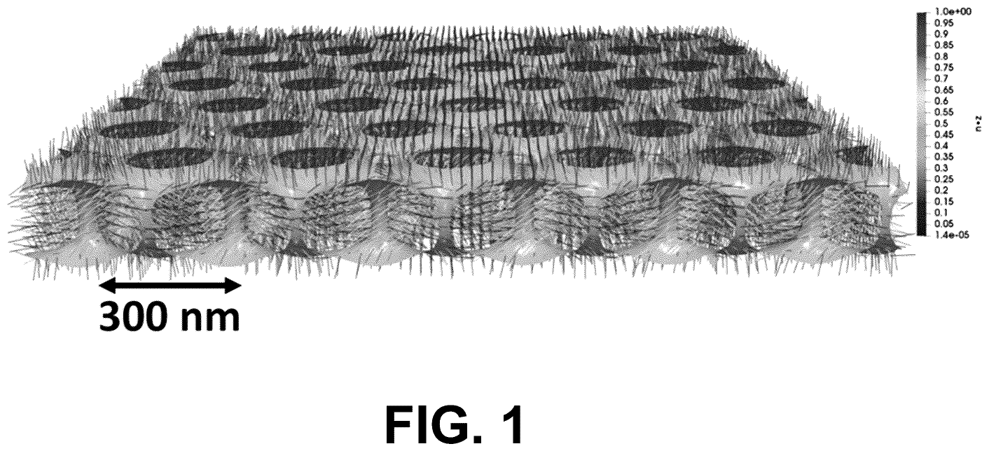

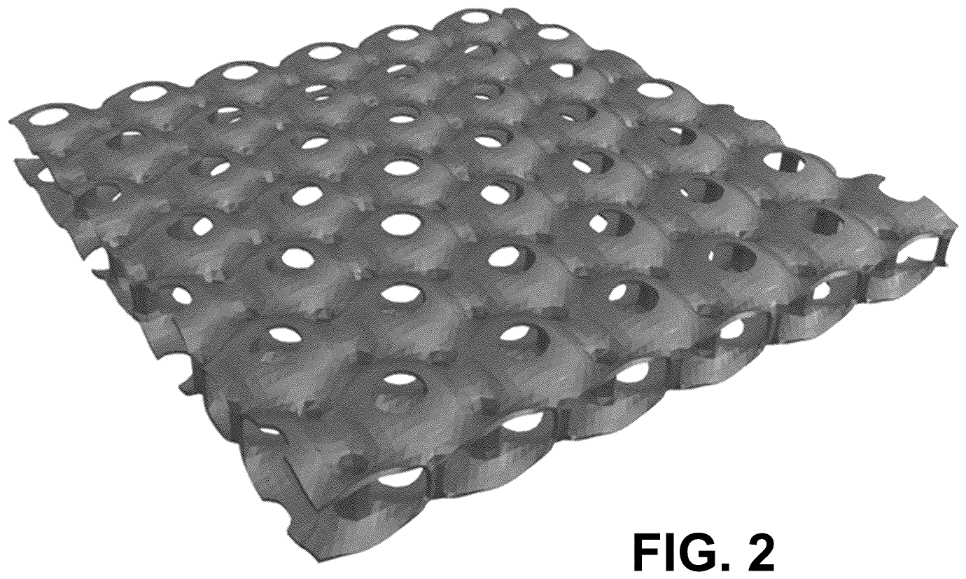

In particular, the designed structure was computationally simulated at the nanoscale as represented by FIGS. 1 and 2. Specifically, FIG. 1 illustrates a generally front and top perspective view of presently disclosed exemplary skyrmions produced from continuum simulation, represented on a scale of hundreds of nms. FIG. 2 illustrates a generally front, left side, and top perspective view of presently disclosed exemplary skyrmions as represented in subject FIG. 1.

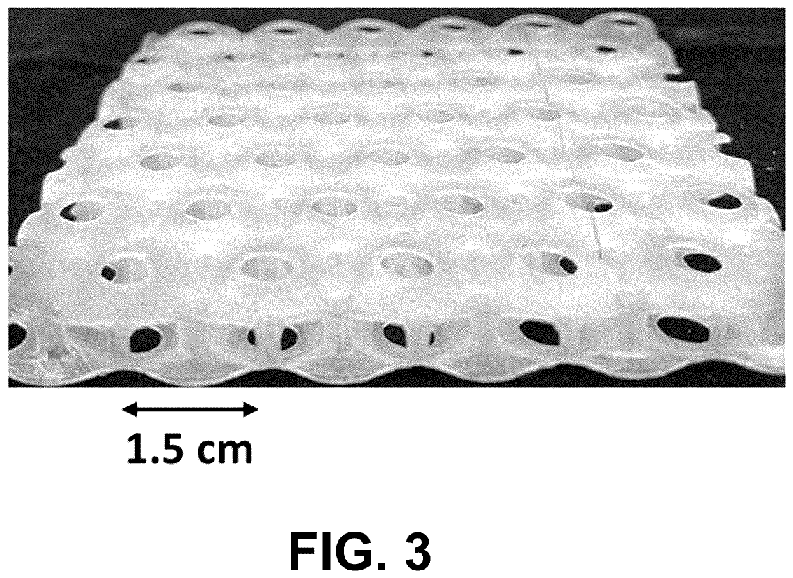

The data obtained by such exercise was converted to a 3D printer-readable file. After scaling up, the simulated designs were 3D printed using different materials in mm and cm scales. FIG. 3 illustrates a generally front and top perspective view of presently disclosed exemplary skyrmions produced from such 3D printing, represented on a scale of cms.

This metamaterial architecture (synthetic composite material with a structure such that it exhibits properties not usually found in natural materials) is designed through the self-assembly process of the small molecules and is thermodynamically driven. The design process is fast, the structure is lightweight and can be scaled up to any size, and 3D printed using different materials, from flexible polymers to metals. This method lowers the production cost and increases the performance of the products. Moreover, by manipulating the structure, the application can be targeted from focusing the waves to harvesting acoustic waves.

Market size can exceed 8 billion dollars and could have applications in such as NASA, Army, Navy, Automotive Industry, Urban Development Organizations, Aviation Industry, Medical Devices and Oceanographic services.

While certain embodiments of the disclosed subject matter have been described using specific terms, such description is for illustrative purposes only, and it is to be understood that changes and variations may be made without departing from the spirit or scope of the subject matter.

What is claimed is:

1. Method for fabricating acoustic metamaterials, comprising:
designing an acoustic metamaterial structure based on skyrmion-like structures for acoustic applications;
producing data for computationally simulating the designed acoustic metamaterial structure at a nanostructure level;
converting the produced data to a 3D printer-readable file;
scaling the 3D printer-readable file to a desired structure size; and
3D printing the skyrmion-like acoustic metamaterials structure.

2. Method in accordance with claim 1, further comprising using predetermined materials for 3D printing, including at least one of flexible polymers and metals.

3. Method in accordance with claim 1, wherein the desired structure size ranges from mm to cm scales.

4. Method in accordance with claim 1, wherein the acoustic application for the metamaterials comprise at least one of sound focusing, sound attenuation, elastic/acoustic energy harvesting, and acoustic cloaking.

5. Method in accordance with claim 1, wherein the designed acoustic metamaterial structure includes spherical shells in a hexagonal or cubic arrangement.

6. Method in accordance with claim 1, wherein producing data includes using Landau-de Gennes mean-field theory to simulate the self-assembly of blue phase liquid crystals and their disclination networks and the conditions under which blue phase skyrmions can be formed and manipulated.

7. Method in accordance with claim 1, wherein producing data includes using simulated nanoscale disclination networks.

8. Method in accordance with claim 1, further comprising producing a plurality of the skyrmion-like acoustic metamaterials structures for assembling into a composite acoustic architecture.

9. Method in accordance with claim 1, wherein designing comprises designing an acoustic metamaterial structure based on the self-assembly of liquid crystal structures for skyrmion-like structures for use for acoustic applications.

10. Method for designing acoustic metamaterials based on liquid crystal skyrmions, comprising:
designing an acoustic metamaterial structure based on the self-assembly of liquid crystal structures for skyrmion-like structures for use for acoustic applications comprising at least one of sound focusing, sound attenuation, elastic/acoustic energy harvesting, and acoustic cloaking;
using simulated nanoscale disclination networks for producing data for computationally simulating the designed acoustic metamaterial structure at a nanostructure level;
converting the produced data to a 3D printer-readable file;
scaling the 3D printer-readable file to a desired structure size; and
3D printing the skyrmion-like acoustic metamaterials structures.

11. Method in accordance with claim 10, further comprising using predetermined materials for 3D printing, including at least one of flexible polymers and metals; and
wherein the desired structure size ranges from mm to cm scales.

12. Method in accordance with claim 10, wherein the designed acoustic metamaterial structure includes spherical shells in a hexagonal or cubic arrangement.

13. Method in accordance with claim 10, wherein producing data includes using Landau-de Gennes mean-field theory to simulate the self-assembly of blue phase liquid crystals and the conditions under which blue phase skyrmions can be formed and manipulated.

14. Method in accordance with claim 10, further comprising producing a plurality of the skyrmion-like acoustic metamaterials structures for assembling into a composite acoustic architecture.

15. Acoustic metamaterials comprising designed skyrmion-like acoustic metamaterials structure formed by 3D printing to a desired structure size, with the acoustic metamaterials structure designed for at least one of sound focusing, sound attenuation, elastic/acoustic energy harvesting, and acoustic cloaking.

16. Acoustic metamaterials according to claim 15, wherein the structure design includes data produced for computationally simulating the designed acoustic metamaterial structure at a nanostructure level, and a 3D printer-readable file based on conversion of such produced data.

17. Acoustic metamaterials according to claim 15, wherein the acoustic metamaterials structure comprises at least one of 3D printed flexible polymers and metals.

18. Acoustic metamaterials according to claim 15, wherein the desired structure size ranges from mm to cm scales.

19. Acoustic metamaterials according to claim 15, wherein the designed acoustic metamaterial structure includes spherical shells in a hexagonal or cubic arrangement.

20. Acoustic metamaterials according to claim 15, further comprising a plurality of the skyrmion-like acoustic metamaterials structures for assembling into a composite acoustic architecture.
